(19) United States
(12) Patent Application Publication
(10) Pub. No.: US 2017/0266821 A1
(43) Pub. Date: Sep. 21, 2017

(54) KNIFE WITH BLADE PROVIDED WITH ENGAGING GROOVE TO FACILITATE ASSEMBLY AND DISASSEMBLY

(71) Applicant: KANTAS PRODUCTS CO., LTD., Taipei City (TW)

(72) Inventor: Yang-Fu CHENG, Taipei City (TW)

(73) Assignee: KANTAS PRODUCTS CO., LTD., Taipei City (TW)

(21) Appl. No.: 15/135,643

(22) Filed: Apr. 22, 2016

(30) Foreign Application Priority Data
Mar. 21, 2016 (TW) 105203915

(51) Int. Cl. B26B 5/00; B25G 3/38

(52) U.S. Cl. CPC B26B 5/00; B25G 3/38

(57) ABSTRACT

The present invention is to provide a knife, which includes a blade having one end formed as a tip and having an engaging groove formed on a side adjacent to the other end thereof; a handle having a side concavely provided with an inwardly extending receiving space and an engaging post fixedly provided therein adjacent to one end thereof and having an elastic plate provided therein adjacent to the other end thereof; and a back-lock member having a first end corresponding to the receiving space, a second end being movably abutted by a free end of the elastic plate, and a middle section pivotally connected in the handle. Thus, when the second end is being pressed, the other end of the blade can be inserted into the receiving space and, is then securely engaged with the engaging post through the engaging groove while the second end is released.

### FIELD OF THE INVENTION

The present invention is to provide a knife, more particularly to a knife having a blade with an engaging groove to facilitate assembly and disassembly, which includes a blade having one end formed as a tip and having the engaging groove formed on a side adjacent to the other end thereof; a handle having a side concavely provided with an inwardly extending receiving space and an engaging post fixedly provided therein adjacent to one end thereof and having an elastic plate provided therein adjacent to the other end thereof; and a back-lock member having a first end corresponding to the receiving space, a second end being movably abutted by a free end of the elastic plate, and a middle section pivotally connected in the handle. Thus, when the second end is being pressed, the other end of the blade can be inserted into the receiving space and, is then securely engaged with the engaging post through the engaging groove while the second end is released

### BACKGROUND OF THE INVENTION

Recently, with the advancement of craft techniques and the improvement of living standards, people who intend to buy a new product consider not only the price and durability of the product, but also whether the product is convenient and safe to use. Such a change in market trends has driven manufacturers and designers in all fields to develop new and better products on a regular basis in order to meet consumers' needs. Take portable knives for use in outdoor recreational activities for example. The demand for both portability and safety has made “folding knives” a very common type of knives, and yet knife manufacturers keep making great efforts to improve their structural details, with a view to further increasing ease of use and durability.

FIG. 1 schematically shows the internal structure of a conventional folding knife 1, which includes a blade 11 and a handle 12. The blade 11 is pivotally connected to the handle 12 at a position adjacent to one end of the handle 12 by a pivot pin. The handle 12 is provided therein with an elastic plate 121 and a back-lock member 122. The elastic plate 121 has one end fixed to the handle 12 at a position adjacent to the other end of the handle 12, while the other end (hereinafter referred to as the second end) of the elastic plate 121 is movably positioned in the handle 12. The back-lock member 122 has a middle section pivotally connected in the handle 12, one end (hereinafter the first end) extending to the vicinity of one end of the blade 11, and the other end abutting against the second end of the elastic plate 121, in order for the elastic plate 121 to push the back-lock member 122, and the first end of the back-lock member 122 to abut against and engage with the aforesaid end of the blade 11, thereby securely positioning the blade 11 outside the handle 12. The back-lock member 122 also has a portion corresponding to the elastic plate 121 and provided with a pressing portion 123. When it is desired to put the blade 11 back into the handle 12, the user presses the pressing portion 123 to bring the first end of the back-lock member 122 out of engagement with the aforesaid end of the blade 11, allowing the blade 11 to rotate toward and then be received in the handle 12.

While the structure of the folding knife 1 makes it possible to fold the blade 11 conveniently by a pressing operation, the inventor of the present invention has found after an observation of market trends that one who plans to buy a knife will assess whether a knife meets the needs of intended “use” in addition to such basic requirements as convenience, portability, and durability, and this attention to practicality can be attributed to the increasingly detailed classification of knives. For instance, the cutting edges of knives can be divided into two major types: plain and serrated. A plain edge is smooth and can cut precisely. A serrated edge, on the other hand, has a larger contact surface during use and therefore cuts with greater ease. Since both types of edges have their respective pros and cons, knives with a partly serrated edge, or combo edge, were invented and are now commercially available.

In light of the fact that a consumer facing the huge variety of knives nowadays would take into account purchase costs, methods of operation, and suitability of use at the same time, the inventor of the present invention began designing a knife structure featuring easy assembly and disassembly to facilitate replacement of its parts. And during the research process, the inventor believed that using and improving the existing knife structures would help reduce product costs and save consumers from the trouble of having to adapt to a brand new structure. Hence, the issue to be addressed by the present invention is to incorporate the concept of a “detachable blade” into the conventional knife structures without incurring any adverse effects on the cost, quality, and durability of the final product.

### BRIEF SUMMARY OF THE INVENTION

Given the fact that most knives on the market do not allow blade replacement, and that the few knives with a detachable blade are extremely complicated in structure, the inventor of the present invention put years of practical experience in research and development into repeated trials and tests and finally succeeded in developing a knife whose blade has an engaging groove to facilitate assembly and disassembly and thereby effectively solve the aforesaid problems of the conventional knives.

It is an objective of the present invention to provide a knife having a blade with an engaging groove to facilitate assembly and disassembly. The knife includes a blade, a handle, and a back-lock member. The blade has one end formed as a tip, one side formed with a first edge, and the opposite side (hereinafter referred to as the second side) formed with an inwardly extending engaging groove. The engaging groove includes a back-lock groove, a passage groove, and a first positioning groove successively arranged along an inward direction. The back-lock groove has one end located at the periphery of the second side of the blade. The passage groove is smaller than the back-lock groove and has one end in communication with the other end of the back-lock groove. The first positioning groove has one end in communication with the other end of the passage groove and is at an angle with respect to the passage groove. The handle has one side concavely provided with an inwardly extending receiving space. An engaging post is fixedly provided in the handle at a position adjacent to one end of the handle. When the other end of the blade extends into the receiving space, the engaging post moves sequentially through the back-lock groove and the passage groove to the aforesaid end of the first positioning groove. By subsequently pushing or pulling the blade, the engaging post is pressed tightly against the other end (hereinafter the second end) of the first positioning groove. As a result, the portion of the blade that corresponds to the first positioning groove is tightly engaged with the engaging post, and assembly of the blade and the handle is completed. In addition, an elastic plate is provided on an inner wall of the handle and is adjacent to the other end of the handle. The elastic plate has a free end movably extending into the receiving space. The back-lock member has one end provided with an abutting portion and the other end formed as a pressing portion. A middle section of the back-lock member is pivotally connected in the handle at a position adjacent to the other side of the handle, with the free end of the elastic plate abutting against the inner side of the pressing portion. Thus, when the engaging post is pressed tightly against the second end of the first positioning groove to bring the blade and the handle into the assembled state, the abutting portion is engaged in the back-lock groove and abuts against the blade to secure the blade and the handle in the assembled state. Conversely, when it is desired to replace the blade, the user only has to press the pressing portion, thereby disengaging the abutting portion from the back-lock groove, and the blade can be pushed and removed from the handle while the engaging post moves sequentially from the first positioning groove through the passage groove to the back-lock groove and finally out of the back-lock groove. As the engaging groove is applicable to various types of blades, one can buy a single handle and many different blades with the same engaging groove and use whichever blade as needed. The knife of the present invention, therefore, has greater flexibility in use and better meets market demands than the existing knifes.

### BRIEF DESCRIPTION OF THE SEVERAL VIEWS OF THE DRAWINGS

To facilitate further understanding of the structural and technical features and operation of the present invention, some illustrative embodiments are detailed below with reference to the accompanying drawings, in which:

FIG. 1 schematically shows a conventional folding knife;

FIG. 2A and FIG. 2B schematically show how the knife in the first preferred embodiment of the present invention is assembled;

FIG. 3 schematically shows the engaging post in the present invention;

FIG. 4 schematically shows the engaging groove in the present invention;

FIG. 5 schematically shows the knife in the second preferred embodiment of the present invention; and

FIG. 6 schematically shows the knife in the third preferred embodiment of the present invention.

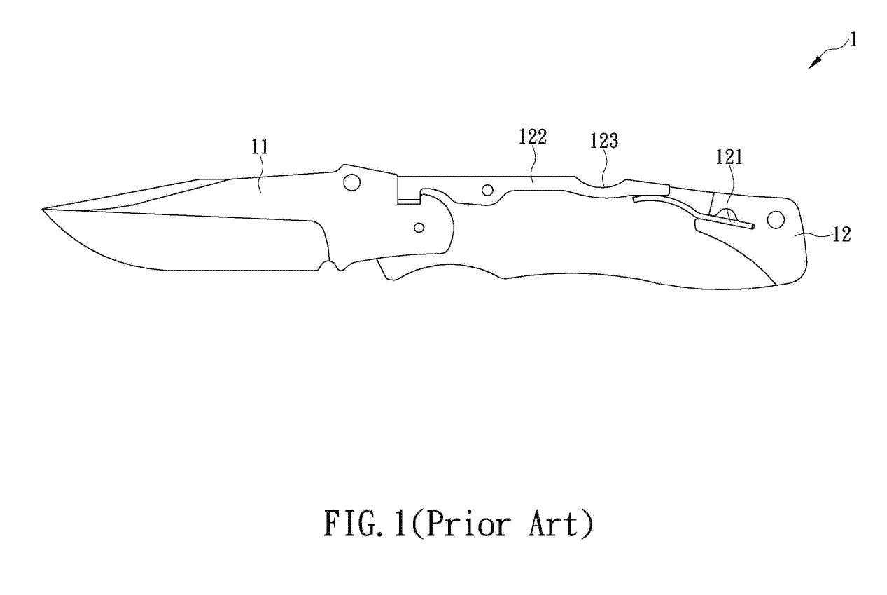

### DETAILED DESCRIPTION OF THE INVENTION

During the research and development process of the present invention, the inventor found that, despite their vast diversity, the existing folding knives are generally based on the same structural principle, i.e., the blade must be fixed to the handle by a “pivot pin” (e.g., a rivet) in order to be received in the handle by rotating around a center defined by the pivot pin. The pivot pin, though essential to the “rotating and folding” function of a folding knife, fixes the blade to the handle and thus prevents the blade from being replaced as desired. The inventor's unconventional design concept lies in a “pivot pin” which is formed as an engaging post to enable “blade replacement” as described in more detailed below.

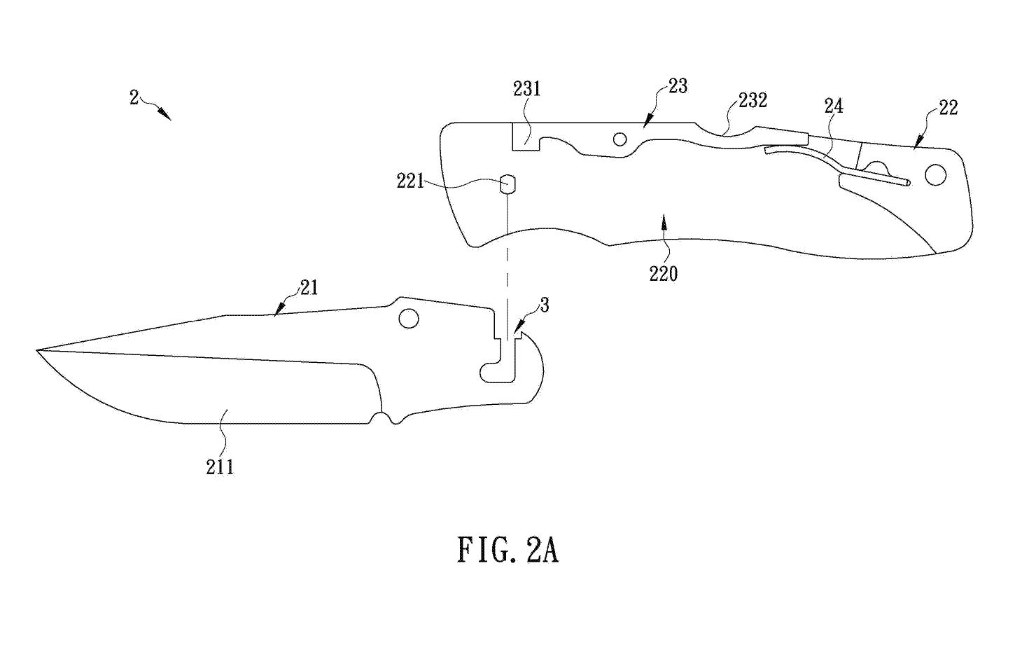

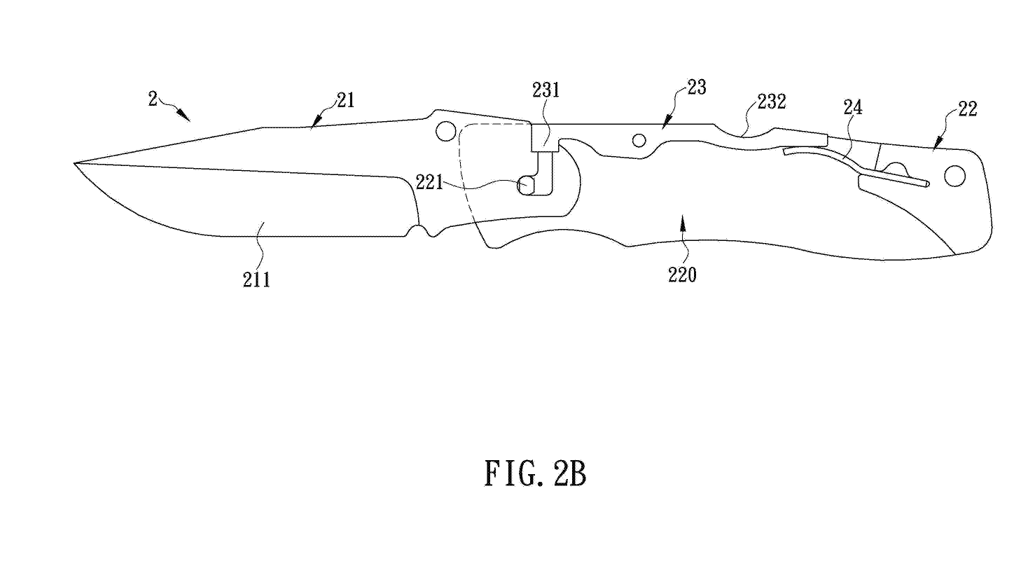

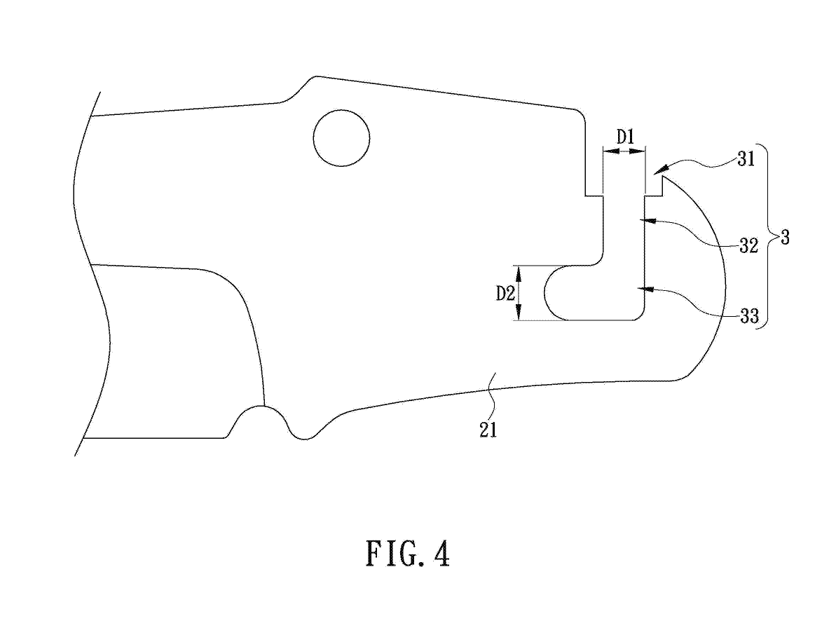

Referring to FIG. 2A to FIG. 4 for the “knife with a blade provided with an engaging groove to facilitate assembly and disassembly” in the first preferred embodiment of the present invention, the knife 2 includes a blade 21, a handle 22, and a back-lock member 23. The blade 21 has one end (hereinafter referred to as the first end) formed as a tip. In addition, a first edge 211 is formed at one side of the blade 21 while an engaging groove 3 extends into the opposite side (hereinafter the second side) of the blade 21. The engaging groove 3 (as shown more clearly in FIG. 4, which is a partial view of the blade 21) includes a back-lock groove 31, a passage groove 32, and a first positioning groove 33 sequentially arranged along an inward direction. The back-lock groove 31 has one end located at the periphery of the second side of the blade 21. The passage groove 32 is smaller than the back-lock groove 31 and has one end in communication with the other end of the back-lock groove 31. The first positioning groove 32 has one end (hereinafter the first end) in communication with the other end (hereinafter the second end) of the passage groove 32 and is at an angle with respect to the passage groove 32.

As to the handle 22, a receiving space 220 extends into one of its sides. An engaging post 221 is fixedly provided in the handle 22 at a position adjacent to one end of the handle 22. When the other end of the blade 21 extends into the receiving space 220, the engaging post 221 moves sequentially through the back-lock groove 31 and the passage groove 32 to the second end of the passage groove 32 (i.e., the first end of the first positioning groove 33). Then, the engaging post 221 is pressed tightly against the other end (hereinafter the second end) of the first positioning groove 33 by pushing the blade 21 toward the other end (hereinafter the second end) of the handle 22. Consequently, the portion of the blade 21 that corresponds to the first positioning groove 33 is tightly engaged with the engaging post 221, and the blade 21 and the handle 22 are in the assembled state. The handle 22 also has an inner wall provided with an elastic plate 24. The elastic plate 24 is adjacent to the second end of the handle 22 and has a free end movably extending into the receiving space 220.

In this embodiment, the angle of the first positioning groove 33 with respect to the passage groove 32 is 90 degrees. More specifically, the second end of the first positioning groove 33 extends toward the first end of the blade 21 to form the angle between the first positioning groove 33 and the passage groove 32. In other preferred embodiments of the present invention, the angle and direction of the first positioning groove 33 may be adjusted as appropriate. For example, the second end of the first positioning groove 33 may extend toward the handle 22 instead. In that case, once the blade 21 is inserted into the receiving space 220, and the engaging post 221 has reached the first end of the first positioning groove 33, the user must “pull” the blade 21 in order to press the engaging post 221 tightly against the second end of the first positioning groove 33.

It should be pointed out that, for the sake of simplicity and to present the core of design of the present invention, FIG. 2A and FIG. 2B show only the essential structures of the handle 22, namely a base plate provided with the engaging post 221 and the elastic plate 24. In practice, the handle 22 may be formed by locking a cover plate to the base plate such that the receiving space 220 is defined between the two plates. Moreover, depending on design requirements, the handle 22 may include an additional handle casing which encloses the cover plate and the base plate and which may be made of a special material (e.g., wood or copper) or have a special pattern (e.g., a decorative or openwork design). As the structure and pattern, if any, of the handle 22 may vary in ways well-known to a person of ordinary skill in the art, no further description is provided herein in this regard.

The back-lock member 23 is configured as a slender plate, with one end provided with an abutting portion 231 and the other end formed as a pressing portion 232. A middle section of the back-lock member 23 is pivotally connected in the handle 22 at a position adjacent to the other side of the handle 22 while the free end of the elastic plate 24 abuts against the inner side of the pressing portion 232. Thus, when the engaging post 221 is pressed tightly against the second end of the first positioning groove 33 to bring the blade 21 and the handle 22 into the assembled state, the abutting portion 231 is engaged in the back-lock groove 31 and abuts against the blade 21 to hold the blade 21 and the handle 22 firmly together and prevent the blade 21 from getting loose.

According to the present invention, the blade 21 and the handle 22 are connected by engagement between the engaging post 221 and the first positioning groove 33. In practice, the width or length of the engaging post 221 may be increased to enlarge the area of engagement, thereby enhancing the stability of the blade 21 in all directions. Besides, as shown in FIG. 2B, the back-lock member 23 further stabilizes the blade 21 with the elastic force of the elastic plate 24. The back-lock member 23, which abuts against the wall of the back-lock groove 31 in the longitudinal direction of the knife 2 (i.e., the direction defined by a line connecting the two ends of the blade 21), also provides support in the longitudinal direction to keep the blade 21 from getting loose.

When it is desired to replace the blade 21, referring to FIG. 2A to FIG. 4, the pressing portion 232 is pressed to disengage the abutting portion 231 from the back-lock groove 31, and then the blade 21 is pushed or pulled, allowing the engaging post 221 to move from the first positioning groove 33 through the passage groove 32 to the back-lock groove 31 and eventually out of the back-lock groove 31 while the blade 21 is detached from the handle 22. It is worth mentioning that the replacement for the detached blade 21 can be a blade of different type. When the cross-sectional shape of the engaging post 221 is free of corners, e.g., circular (or elliptical as shown in FIG. 2A and FIG. 2B, for reasons given further below), the engaging post 221 serves as a “pivot pin”. That is to say, when it is desired to fold the blade 21 into the handle 22, the user can, after pressing the pressing portion 232 to disengage the abutting portion 231 from the back-lock groove 31, push or rotate the blade 21 about a center of rotation defined by the engaging post 221 so as to put the first end of the blade 21 into the handle 22.

The engaging groove 3 can be formed in different types of blades 21 so that a single handle 22 can be used in combination with various blades 21 as needed. As a user can replace the blades 21 by himself/herself, the knife 2 of the present invention not only allows the blade 21 in use to be rotated into and out of the handle 22, but also functions as a knife with a “replaceable blade” and features convenient blade replacement. The knife 2 therefore is more flexible in use and can better meet market demands than its conventional counterparts.

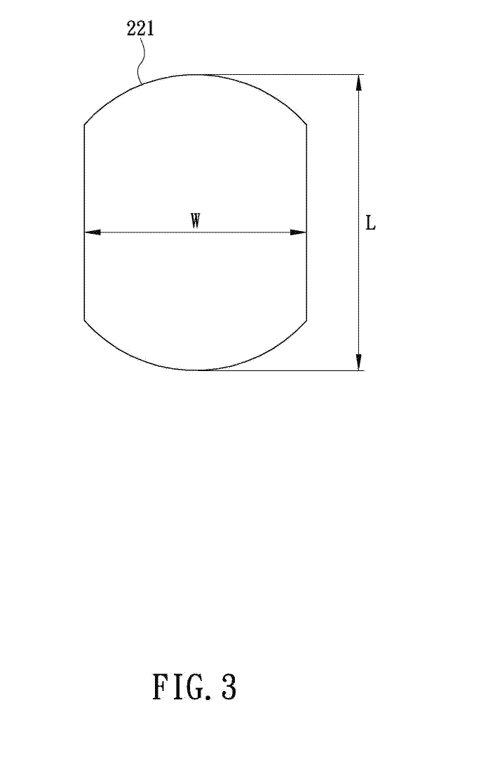

According to the present invention, the shape of the engaging post 221 can be modified to enhance positioning stability. Referring to FIG. 3 and FIG. 4, the engaging post 221 in this embodiment has a generally elliptical, rather than circular, cross section with a length L and a width W. To ensure high stability, the width D1 of the passage groove 32 can be designed as equal to the width W of the engaging post 221, and the width D2 of the first positioning groove 33, as equal to or slightly less than the length L of the engaging post 221 such that the portion of the blade 21 that corresponds to the first positioning groove 33 is deformed when engaged with the engaging post 221. Please note that the cross section of the engaging post 221 in FIG. 3 has peripheral “corners” to further increase the strength of engagement. The corners, however, make it difficult to rotate the blade 21 into the receiving space 220. A give and take in design is hence necessary regarding the cross-sectional shape of the engaging post 221.

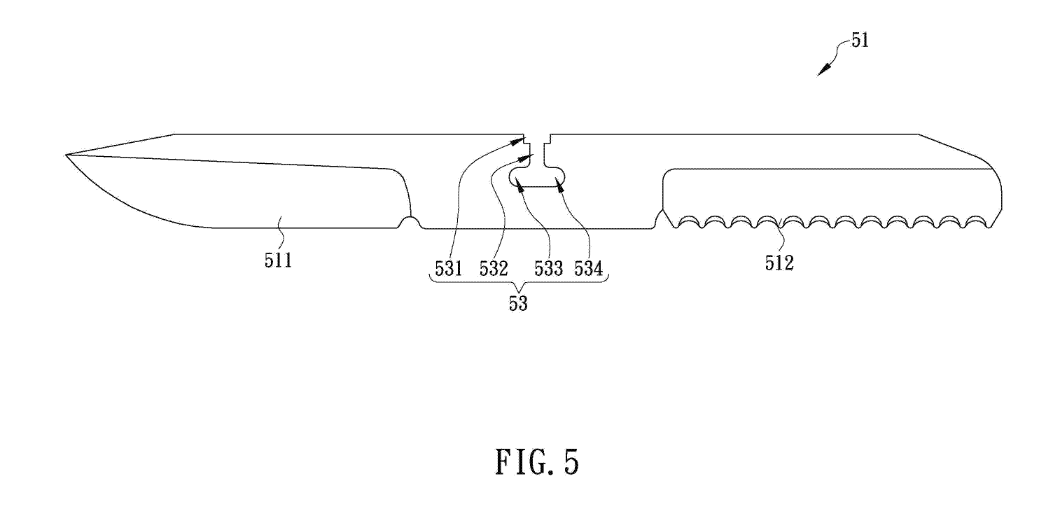

FIG. 5 shows the second preferred embodiment of the present invention, in which the blade 51 forms a first tip at one end and is provided with a first edge 511 and a second edge 512 at one side. The second edge 512 extends toward the opposite end (hereinafter the second end) of the blade 51. Moreover, the second edge 512 (e.g., a serrated edge) is different in configuration from the first edge 511 (e.g., a plain edge). In this embodiment, the engaging groove 53 includes a back-lock groove 531, a passage groove 532, a first positioning groove 533, and a second positioning groove 534. The passage groove 532 has one end in communication with the back-lock groove 531 and the other end (hereinafter the second end) in communication with one end (hereinafter the first end) of each positioning groove 533, 534 (in other words, the first end of the second positioning groove 534 is also in communication with the second end of the passage groove 532). The other end (hereinafter the second end) of the second positioning groove 534 extends toward the second end of the blade 51.

Use of the blade 51 is described below as applied to the handle 22 depicted in FIG. 2 and FIG. 3. When the engaging post 221 is engaged with the other end of the first positioning groove 533 such that the blade 51 and the handle 22 are in the assembled state, the second edge 512 is in the receiving space 220. Once detached from the handle 22 and turned over along the longitudinal direction of the knife 2, the blade 51 can be reinserted into the handle 22, with the engaging post 221 moving sequentially through the back-lock groove 531 and the passage groove 532 to the first end of the second positioning groove 534. After that, the blade 51 can be pushed toward the second end of the handle 22 such that the engaging post 221 is pressed tightly against the second end of the second positioning groove 534. As a result, the portion of the blade 51 that corresponds to the second positioning groove 534 is tightly engaged with the engaging post 221, and the second edge 512 is securely positioned outside the handle 22.

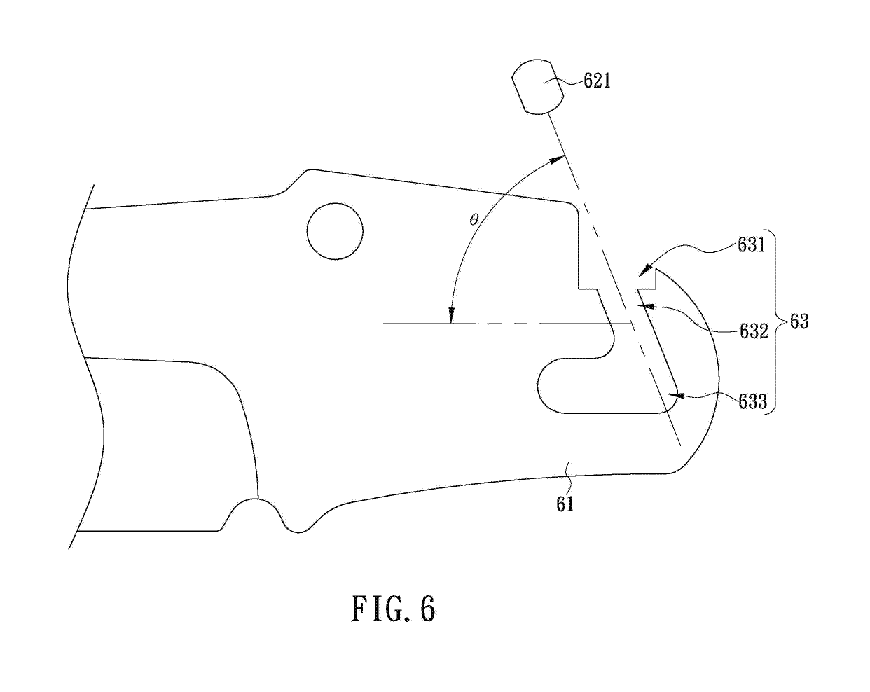

In the third preferred embodiment of the present invention as shown in FIG. 6, the engaging groove 63 also includes a back-lock groove 631, a passage groove 632, and a first positioning groove 633, but the angle θ between the passage groove 632 and the first positioning groove 633 (or between the passage groove 632 and the longitudinal direction of the blade 61, the first positioning groove 633 in this embodiment being parallel to the longitudinal direction of the blade 61) is less than 90 degrees. Thus, even if the blade 61 becomes loose due to an external force and allows the engaging post 621 to move to the end of the first positioning groove 633 that is in communication with the passage groove 632, the engaging post 621 will not move further outward along the passage groove 632 easily. This ensures that the blade 61 will not fall off the handle instantly when impacted by a large external force.

The technical features of the foregoing three embodiments can be used in conjunction with one another. In the second preferred embodiment, for example, the angle between the passage groove 532 and the first positioning groove 533 and the angle between the passage groove 532 and the second positioning grooves 534 may also be adjusted as appropriate, and the widths of the positioning grooves 533 and 534 may also be designed as slightly less than the length L of the engaging post 221 so that the blade 51 must deform in order to engage with the engaging post 221.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A knife with a blade provided with an engaging groove to facilitate assembly and disassembly, comprising:
a blade having a first end formed as a point, a first side formed with a first edge, and a second side formed with an inwardly extending engaging groove, wherein the engaging groove comprises a back-lock groove, a passage groove, and a first positioning groove sequentially arranged along an inward direction; the back-lock groove has a first end located at a periphery of the second side of the blade; the passage groove is smaller than the back-lock groove and has a first end in communication with a second end of the back-lock groove; and the first positioning groove has a first end in communication with a second end of the passage groove and is at an angle with respect to the passage groove;
a handle having a first side concavely provided with an inwardly extending receiving space, the handle being fixedly provided therein with an engaging post adjacent to a first end of the handle, wherein when a second end of the blade extends into the receiving space, the engaging post moves sequentially through the back-lock groove and the passage groove to the first end of the first positioning groove; and by subsequently pushing or pulling the blade, the engaging post is pressed tightly against a second end of the first positioning groove such that a portion of the blade that corresponds to the first positioning groove is tightly engaged with the engaging post, bringing the blade and the handle into an assembled state; the handle further having an inner wall provided with an elastic plate adjacent to a second end of the handle, the elastic plate having a free end movably extending into the receiving space; and
a back-lock member having a first end provided with an abutting portion, a second end forming a pressing portion, and a middle section pivotally connected in the handle at a position adjacent to a second side of the handle, the free end of the elastic plate abutting against an inner side of the pressing portion such that, when the engaging post is pressed tightly against the second end of the first positioning groove to bring the blade and the handle into the assembled state, the abutting portion is engaged in the back-lock groove and abuts against the blade to secure the blade and the handle in the assembled state; and when it is desired to replace the blade, the blade is detachable from the handle by pressing the pressing portion to disengage the abutting portion from the back-lock groove and by subsequently pushing the blade in such a way that the engaging post moves from the first positioning groove through the passage groove to the back-lock groove and then out of the back-lock groove.

2. The knife of claim 1, wherein the first side of the blade is further provided with a second edge extending toward the second end of the blade; the second edge is different from the first edge in configuration; the blade is further formed with a second positioning groove; the second positioning groove has a first end in communication with the second end of the passage groove and a second end extending toward the second end of the blade; when the engaging post is engaged with the second end of the first positioning groove to bring the blade and the handle into the assembled state, the second edge is in the receiving space; when the blade re-extends into the handle after being detached therefrom and turned over in a longitudinal direction of the knife, the engaging post moves sequentially through the back-lock groove and the passage groove to the first end of the second positioning groove; and by subsequently pushing or pulling the blade, the engaging post is pressed tightly against the second end of the second positioning groove such that a portion of the blade that corresponds to the second positioning groove is tightly engaged with the engaging post to position the second edge securely outside the handle.

3. The knife of claim 1, wherein the passage groove has a width equal to a width of the engaging post, and the first positioning groove (or each of the first positioning groove and second positioning groove) has a width less than a length of the engaging post such that the portion of the blade that corresponds to the first positioning groove (or each said portion of the blade that corresponds to either the first positioning groove or the second positioning groove) is deformed when engage with the engaging post.

4. The knife of claim 2, wherein the passage groove has a width equal to a width of the engaging post, and the first positioning groove (or each of the first positioning groove and second positioning groove) has a width less than a length of the engaging post such that the portion of the blade that corresponds to the first positioning groove (or each said portion of the blade that corresponds to either the first positioning groove or the second positioning groove) is deformed when engage with the engaging post.

5. The knife of claim 3, wherein the second end of the first positioning groove extends toward the first end of the blade such that the first positioning groove is at the angle with respect to the passage groove.

6. The knife of claim 4, wherein the second end of the first positioning groove extends toward the first end of the blade such that the first positioning groove is at the angle with respect to the passage groove.

7. The knife of claim 5, wherein the angle is 90 degrees.

8. The knife of claim 6, wherein the angle is 90 degrees.

9. The knife of claim 7, wherein the angle is less than 90 degrees.

10. The knife of claim 8, wherein the angle is less than 90 degrees.
